(19) United States
(12) Patent Application Publication
(10) Pub. No.: US 2013/0087679 A1
(43) Pub. Date: Apr. 11, 2013

(54) RELOCATION AND SUPPORT DEVICE

(71) Applicant: Daniel J. Mooney, Massapequa, NY (US)

(72) Inventor: Daniel J. Mooney, Massapequa, NY (US)

(21) Appl. No.: 13/437,820

(22) Filed: Apr. 2, 2012

Related U.S. Application Data
(60) Provisional application No. 61/516,195, filed on Mar. 31, 2011.

(51) Int. Cl. F16M 11/24

(52) U.S. Cl. CPC F16M 11/24
USPC 248/669; 414/800

(57) ABSTRACT

The present invention relates to the relocation and support of construction equipment. Specifically, the invention relates a relocation and support device which supports a machine on a working deck by transferring the machine load to the structure through reaction collar assembly units. Additionally, the invention enables the vertically relocation of a machine.

### RELATED APPLICATION DATA

This application claims the benefit of priority under 35 U.S.C. §119(e) of the U.S. Patent Application No. 61/516,195 filed Mar. 31, 2011, the entire content of which is incorporated herein by reference.

### FIELD OF THE INVENTION

The present invention is in the technical field of construction equipment. More particularly, the present invention is in the technical field of cranes, derricks, pumps, material hoisting and any type of construction related machinery or equipment.

### BACKGROUND INFORMATION

Structures such as multistory buildings are usually built one level at a time. As each level is completed, the construction equipment needed for build the next level must be relocated to the higher level. Currently, this process involves the permanent erection and placement of construction equipment and devices. There is a need for a device that can vertically relocate pieces of construction equipment quickly and efficiently without installing permanent pieces of construction equipment or devices.

The present invention is a device that could be utilized to support a construction machine of any type, size, capacity, design, function, or method of manufacture including but not limited to: cranes, derricks, jibs, hoists, winch's, drum's concrete pumps or other devices used in construction. The invention could than be used to assist in the support, relocation, hoisting, jacking, jumping, raising or any other term used to describe the lifting of the invention vertically to different levels of a building or other structure. A failsafe mechanism is incorporated as a unique safety feature.

### SUMMARY OF THE INVENTION

The present invention relates to the relocation and support of construction equipment. Specifically, the invention relates a relocation and support device which supports a machine on a working deck by transferring the machine load to the structure through reaction collar assembly units. Additionally, the invention enables the vertically relocation of a machine.

In one embodiment, the present invention provide for a relocation and support device for a machine. In one aspect the relocation and support device is attached to a machine. The relocation and support device includes a mounting flange; at least one relocation sheave; a reaction collar assembly; a reaction pipe; a bearing pin; a relocation cable; and a cable dead end. In one aspect, the relocation and support device optionally includes a relocation hoist, a second upper relocation sheave and or a power unit.

In one aspect, the reaction collar assembly of the relocation and support device includes: a reaction collar plate, a thrust angle, a stiffener plate, a bearing beam assembly, a lifting beam, a lifting beam pin, a failsafe assembly, a wedge block, a spacer block, a shim plate, a failsafe stop roller, a failsafe adjustment bolt and a failsafe seating bolt.

In another aspect, the failsafe system of the relocation and support device of includes: a failsafe assembly, a wedge block, a spacer block, a shim plate, a failsafe stop roller, a failsafe adjustment bolt and a failsafe seating bolt. In a further aspect, the wedge block of the failsafe system has an angle such that it prevents downward movement of the reaction pipe and machine. In a preferred aspect, the wedge block has a 7-10 degree angle.

In yet another aspect, the reaction collar assembly of the relocation and support device can be relocated as the machine is vertically relocated.

In another embodiment, the invention provides for a method of relocating a machine. The method includes: secure a lifting or relocation cable to a bearing beam pipe which is attached to a lifting beam; a power source rotates a relocation hoist a sheave or series of sheaves; and a relocation cable winds over a relocation sheave onto or over the relocation hoist, sheave or sheaves; wherein the machine is lifted to a higher vertical position.

In a further embodiment, the present invention provides for the use of a relocation and support device to relocate a machine.

In one embodiment, the present invention provides for the use of a relocation and support device to support a machine by transferring the machine load and the loads imposed by the machine.

### BRIEF DESCRIPTION OF THE DRAWINGS

FIG. 1 is a drawing of the relocation and support device on the relocation reaction floor of a structure. A. the machine; B. the pedestal of the machine; C. the upper relocation sheave(s); D. the mounting flange; E. reaction pipe; F. reaction collar assembly; G. lower relocation sheave; H. relocation cable; I. cable dead end; J. shoring posts or dunnage.

FIG. 2 is a drawing of the reaction collar assembly. A. lift beam assembly with safety pin; B. lift beam assembly; C. thrust angles; D. stiffener plates; E. reaction collars; F. bearing beams.

FIG. 3 is a drawing of the reaction collar assembly showing the placement of the bearing pin. A. reaction pipe; B. bearing pin with safety pin; C. reaction collar assembly.

FIG. 4 is a drawing of the failsafe system. A. failsafe seating bolt; B. shim plate; C. failsafe stop roller; D. wedge block; E. spacer block; F. failsafe adjustment lock; G. bearing reaction collar assembly.

### DETAILED DESCRIPTION OF THE INVENTION

The present invention relates to the relocation and support of construction equipment. Specifically, the invention relates to a relocation and support device which supports a machine on a relocation reaction floor, or highest floor yet to be constructed, by transferring the machine load to the structure through reaction collar assembly units. Additionally, the invention enables the vertically relocation of a machine.

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

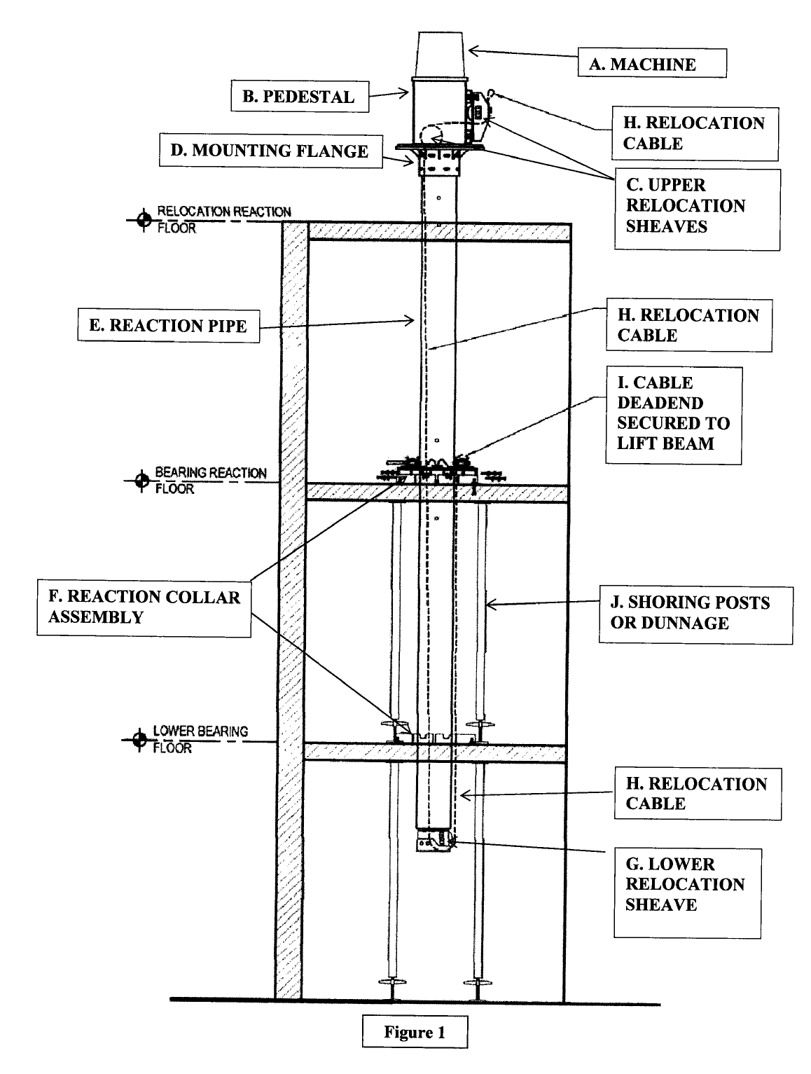

“Relocation and support device” refers to any device which can provide support for a machine (FIG. 1A) by transferring the load of the machine (FIG. 1A) to a structure and which can also vertically relocate a machine (FIG. 1A).

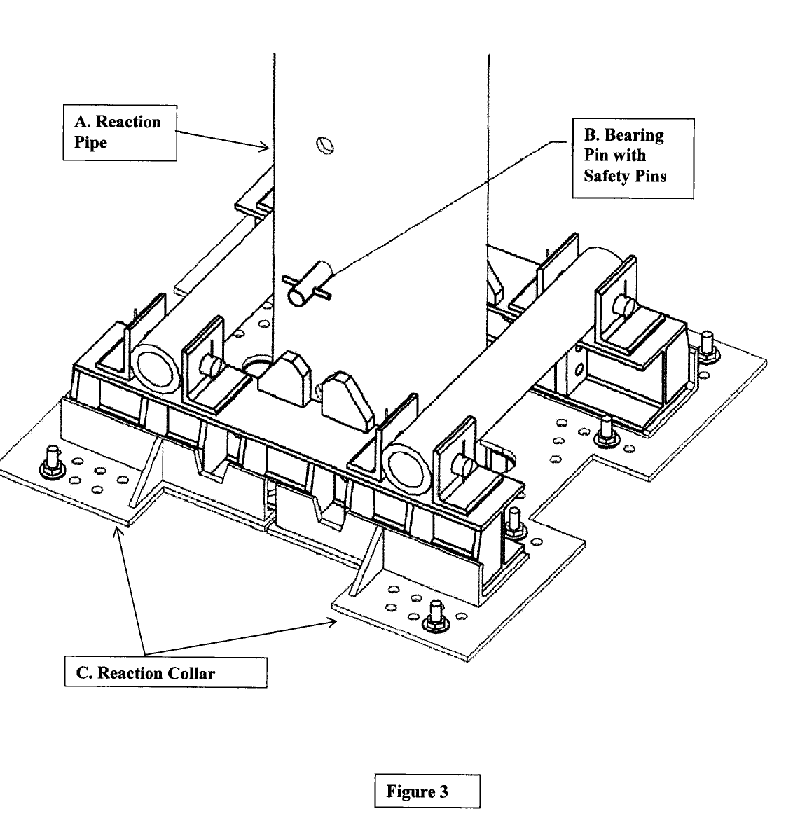

In one embodiment a relocation and support device includes the following components: a mounting flange (FIG. 1D), at least one relocation sheave (FIG. 1C & 1G), a reaction pipe (FIG. 1E), a bearing pin (FIG. 3B), a relocation cable (FIG. 1H), a cable dead end (FIG. 1I), a reaction collar assembly (FIG. 1F). The relocation and support device may optionally include a relocation hoist and/or a power unit. The relocation and support device is located on a relocation reaction floor or the highest floor yet to be constructed.

“Machine” refers to of any piece of construction equipment which needs to be supported or vertically relocated. Examples of a machine include but are not limited to cranes, derricks, jibs, hoists, winch's, drum's concrete pumps or other devices used in construction. In one aspect the relocation and support device is attached to a machine (FIG. 1A) at the mounting flange (FIG. 1D) using bolts. The machine (FIG. 1A) could be, but is not required to be, mounted in various ways and methods to a vertical pedestal (FIG. 1B) of various sizes, shapes, dimensions and materials including but not limited to metal, wood, plastics, composites or any other material and methods of manufacture. In another aspect the relocation and support device is attached to the machine (FIG. 1A) at the pedestal (FIG. 1B).

“Relocation reaction floor” refers to the level of a structure on which the machine is currently located.

The mounting flange (FIG. 1D) attaches the machine (FIG. 1A) to the relocation and the support device. The machine is connected to the mounting flange mounting flange (FIG. 1D) by the means specified by the manufacturer of the machine, by welding, bolting or any structurally acceptable method, most often by using bolts. The mounting flange (FIG. 1D) can be any size. In one aspect, the mounting flange (FIG. 1D) is 2 foot-8 foot in any shape. In a preferred aspect, the mounting flange (FIG. 1D) is 2 foot×2 foot square. The mounting flange (FIG. 1D) has a hole manufactured into it which allows the relocation cable to pass through and facilitates the attaching of the reaction pipe (FIG. 1E). The hole can be 6 inches-48 inches in diameter. In a preferred aspect, the hole is 16 inches in diameter. The mounting flange (FIG. 1D) can be made of any material. In one aspect the mounting flange (FIG. 1D) can be made of metal, wood, plastics, composites or any other material and methods of manufacture. In a preferred aspect the mounting flange (FIG. 1D) is made of steel.

The relocation and support device of the invention has at least one upper relocation sheave (FIG. 1C) and one lower relocation sheave (FIG. 1G) but may have more.

The first upper relocation sheave (FIG. 1C) is attached to the mounting flange (FIG. 1D) or the pedestal (FIG. 1B). A sheave is a wheel or roller with a groove along its edge for holding a belt, rope or cable. When hung between two supports and equipped with a belt, rope or cable, one or more sheaves make up a pulley. The words sheave and pulley are sometimes used interchangeably. A sheave can also refer to a pulley which has an adjustable operating diameter for use with a belt. This is accomplished by constructing the pulley out of several pieces. The two main “halves” of the pulley can be moved closer together or farther apart, thus altering the operational diameter. The usual construction is some sort of locking collar or set screws to secure the components, one half with a threaded central shaft and one half with a threaded center.

The first upper relocation sheave (FIG. 1C) acts as a guide for the relocation cable (FIG. 1H) to a hoist or to a second upper relocation sheave (FIG. 1C) that could facilitate attaching the relocation cable to the hoist or hoist cable of the machine. The hoist may be a relocation hoist attached to the mounting flange (FIG. 1D), may be part of the machine (FIG. 1A) or a separate stand alone unit. The first upper relocation sheave (FIG. 1C) can be any shape. In one aspect, the first upper relocation sheave (FIG. 1C) is round. The first upper relocation sheave (FIG. 1C) can be made of any material. In one aspect the first upper relocation sheave (FIG. 1C) is made of metal, wood, plastics, composites or any other material and methods of manufacture. In a preferred aspect, the first upper relocation sheave (FIG. 1C) is made of steel. The first upper relocation sheave (FIG. 1C) can be of any size. In one aspect, the first upper relocation sheave (FIG. 1C) is 6-20 inches diameter. In a preferred aspect the first upper relocation sheave (FIG. 1C) is 10 inches in diameter. The first upper relocation sheave (FIG. 1C) could be attached to the mounting flange (FIG. 1D) inside the pedestal or attached directly to the pedestal by welding, bolting or any structurally acceptable method. The first upper relocation sheave (FIG. 1C) may be a sheave, pulley or roller, or one or more sheaves, pulleys or rollers with or without a manual or power operated hoist.

The first upper relocation sheave (FIG. 1C) is attached inline to a second upper relocation sheave (FIG. 1C) or a hoist which is either a relocation hoist attached to the mounting flange (FIG. 1D), a hoist attached to the machine, or the hoist could be a separate stand alone unit. A hoist is a device used for lifting or lowering a load by means of a drum or lift-wheel around which rope or chain wraps. It may be manually operated, electrically or pneumatically driven and may use chain, fiber or wire rope as its lifting medium. The hoist acts to vertically relocate the machine (FIG. 1A) by wrapping the relocation cable (FIG. 1H) around a roller. The hoist or second upper relocation sheave (FIG. 1C) is attached to the pedestal (FIG. 1B) and/or mounting flange (FIG. 1D). The hoist may be a manual or power operated hoist, winch or other lifting device. The hoist or relocation hoist or the second upper relocation sheave (FIG. 1C) may be of any size. In one aspect, the hoist or second upper relocation sheave (FIG. 1C) is 6 inches-36 inches diameter. In a preferred aspect, the hoist or second upper relocation sheave (FIG. 1C) is 10 inches diameter. The hoist or second upper relocation sheave (FIG. 1C) may be made of any material. In one aspect the hoist or second upper relocation sheave (FIG. 1C) is made from metal, wood, plastics, composites or any other material and methods of manufacture. In a preferred, aspect the hoist or second upper relocation sheave (FIG. 1C) is made from steel.

A lower relocation sheave (FIG. 1G) is located at the end or bottom of the reaction pipe (FIG. 1E). The lower relocation sheave (FIG. 1G) can be made of any material. In one aspect, the lower relocation sheave (FIG. 1G) is made of metal, wood, plastics, composites or any other material and methods of manufacture. In a preferred aspect, the lower relocation sheave (FIG. 1G) is made of steel. The lower relocation sheave (FIG. 1G) can be of any size. In one aspect, the lower relocation sheave (FIG. 1G) is 6 inches-36 inches diameter. In a preferred aspect, the lower relocation sheave (FIG. 1G) is 12 inches diameter. The lower relocation sheave (FIG. 1G) is attached to the reaction pipe (FIG. 1E) by welding, bolting or any structurally acceptable method. Additional relocation sheaves may be used as necessary.

A power unit can be attached to the machine or stand separately. The source of power generation would be attached the machine by the method required by the chosen power unit. This could be hydraulic hoses, electrical wires, fiber optic cables or any other method or source. The power unit acts to provide power to the machine and hoist. The power unit can be of manual, diesel, gasoline, propane, electric, fluid, solar or any other power source yet to be discovered.

The mounting flange (FIG. 1D), first upper relocation sheave (FIG. 1C), power unit and optionally a relocation hoist or second upper relocation sheave (FIG. 1C) may be separate components or encased as a single unit.

The mounting flange (FIG. 1D), first upper relocation sheave (FIG. 1C) and optionally a relocation hoist or second upper relocation sheave (FIG. 1C) is then attached collectively or separately to at least one reaction pipe (FIG. 1E) or similar vertical support. The reaction pipe (FIG. 1E) extends through a hole or shaft just slightly larger than the chosen size of the reaction pipe at least two floors below the mounting flange (FIG. 1D) and relocation reaction floor or the highest floor yet to be constructed through the support dunnage. The support dunnage is optional and its use is determined by the structural design of the structure upon which the relocation and support device is mounted to. Its purpose would be to add support to the invention if necessary.

The reaction pipe (FIG. 1E) houses the relocation cable (FIG. 1H). The reaction pipe (FIG. 1E) is attached to the mounting flange (FIG. 1D) by welding, bolting or any structurally acceptable method. The reaction pipe (FIG. 1E) must be hollow, houses a relocation cable (FIG. 1H) and has a lower relocation sheave (FIG. 1G) attached to the lowest point of the reaction pipe. The reaction pipe (FIG. 1E) can be of any size. In one aspect, the reaction pipe (FIG. 1E) is 6 inches-48 inches diameter. In a preferred aspect, the reaction pipe (FIG. 1E) is 16 inches in diameter and by ¼ inches thick. The reaction pipe (FIG. 1E) can be made of any material. In one aspect, the reaction pipe (FIG. 1E) is made of metal, wood, plastics, composites or any other material and methods of manufacture. In a preferred aspect, the reaction pipe (FIG. 1E) is made of steel.

The reaction collar assembly (FIG. 1F) is attached to each bearing floor below the relocation reaction floor or the highest floor yet to be constructed through which the reaction pipe (FIG. 1E) passes. The reaction collar assembly (FIG. 1F) rests on or is secured to the building structure, in various methods, thus transferring the imposed loads from the machine (FIG. 1A) to the building structure. Unlike similar devices, the reaction collar assembly (FIG. 1F) of the invention is manufactured with cutouts or in such a way that allows the use of support dunnage or posts in the original structure to fit inside or around the reaction collar assembly and since it is not attached to the post in the structure the reaction collar assembly (FIG. 1F) of the invention is movable and is not permanently attached to the structure. In one embodiment of the invention, the reaction collar assembly (FIG. 1F) is relocated and reused at a higher level in the structure as the machine (FIG. 1A) is vertically relocated as is the reaction collar assembly (FIG. 1F) of the invention. A separate reaction collar, assembly or similar device or components may or may not be secured to several locations or floors as required. The floor or deck that has a reaction collar assembly with a cable dead end is referred to as a bearing reaction floor. The floor or deck that has a reaction collar assembly without a cable dead end is referred to as a lower reaction floor.

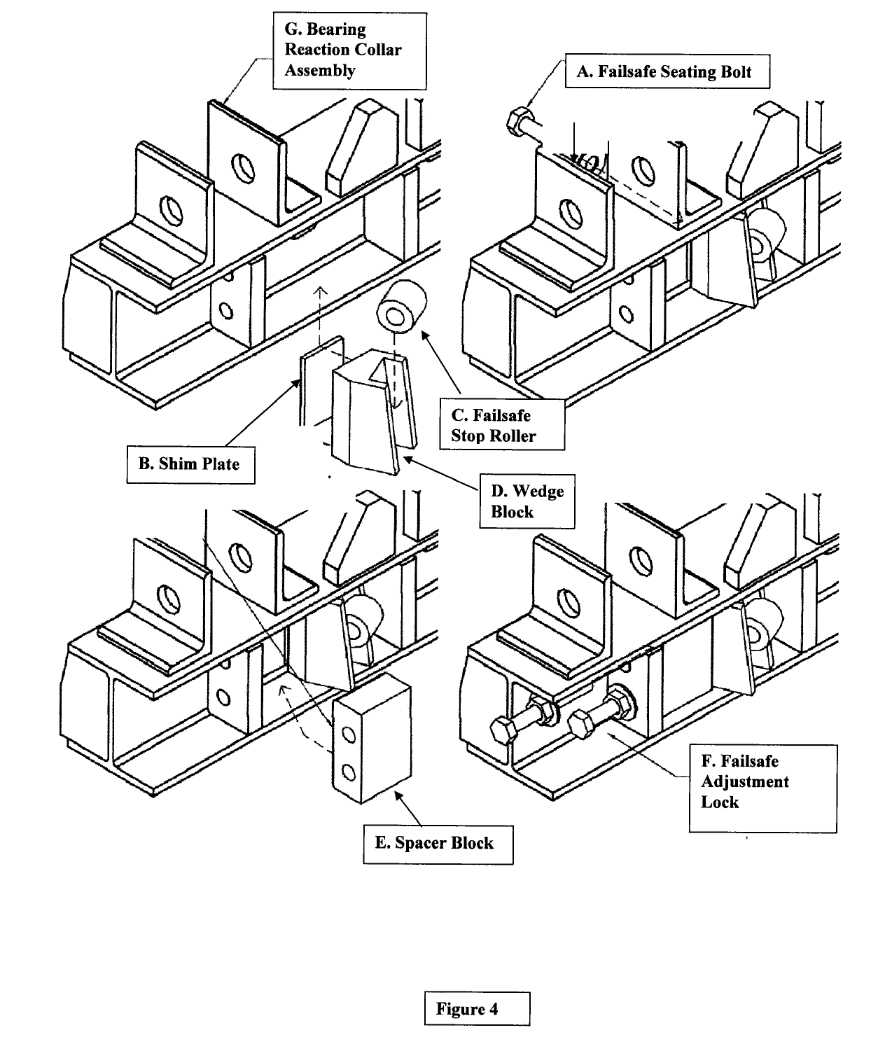

Additionally, unlike similar devices, the reaction collar assembly (FIG. 1F) of the invention utilizes a unique fail safe system to prevent the machine (FIG. 1A) from falling if the relocation cable (FIG. 1H) malfunctions. The failsafe system has the following components: a failsafe assembly or locks, a wedge block (FIG. 4D), a spacer block (FIG. 4E), shim plates (FIG. 4B), a failsafe stop roller (FIG. 4C), failsafe adjustment bolts (FIG. 4F), a failsafe seating bolt (FIG. 4A). The failsafe system has several unique functions such as an additional stabilizing attachment to the reaction collar assembly and as a positive mechanical gravity applied locking device such that the wedge block (FIG. 4D) is on an angle which as the reaction pipe ascends vertically, the failsafe roller is pushed up away from the reaction pipe (FIG. 1E) during the relocation operation. If the reaction pipe (FIG. 1E) started to descend for any reason the weight of the invention and the attached machine would cause the failsafe roller to move down the angle of the wedge block (FIG. 4D) and thus causes the failesafe roller to wedge against the reaction pipe (FIG. 1E) and stop the descent of the reaction pipe, the invention and the attached machine (FIG. 1A). One reaction collar assembly (FIG. 1F) requires at least 4 failsafe assemblies and only one reaction collar assembly is required to have the failsafe assembly. But they can be installed on multiple reaction collar assemblies for an extra safety factor.

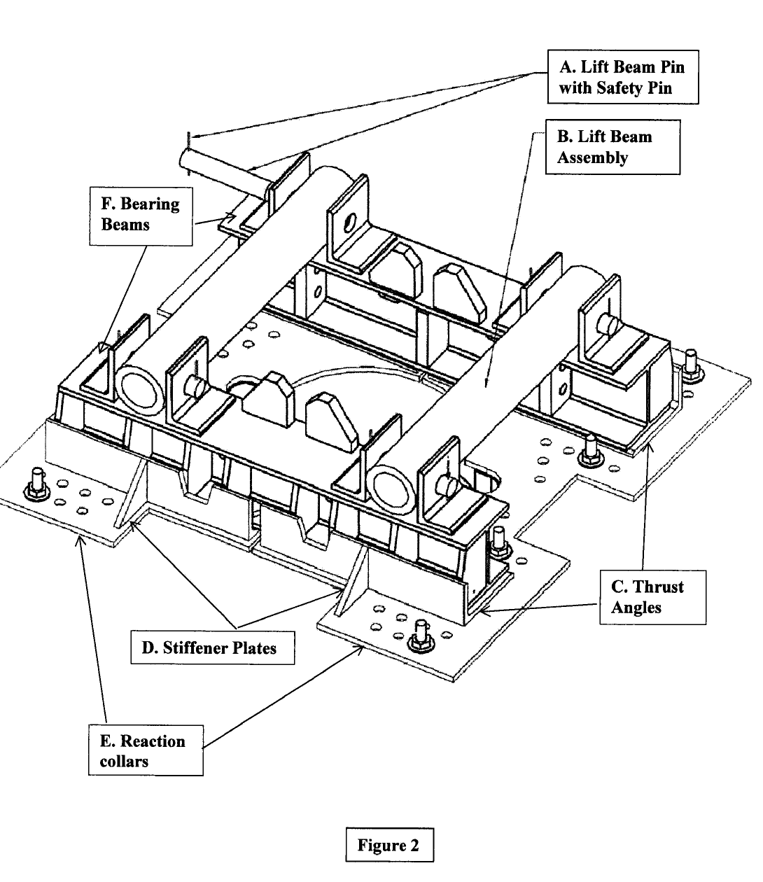

The reaction collar assembly is made has at least one of the following components: a reaction collar plate, a thrust angle (FIG. 2C), stiffener plates (FIG. 2D), a bearing beam assembly (FIG. 2F), a lifting beam, a lifting beam pipe, a lifting beam pin, a failsafe assembly or locks, a wedge block (FIG. 4D), a spacer block (FIG. 4E), a shim plates (FIG. 4B), a failsafe stop roller (FIG. 4C), failsafe adjustment bolts (FIG. 4F)and a failsafe seating bolt (FIG. 4A).

The reaction collar plate (FIG. 2E) is attached to each bearing floor below the relocation reaction floor or the highest floor yet to be constructed that the reaction pipe passes through and is designed with specific cut outs to accommodate post(s) or support dunnage thus lining the support dunnage of the structure. reaction collar plate (FIG. 2E) can be of various shapes and sizes. In one aspect, reaction collar plate (FIG. 2E) is 6 inches to 72 in length and width in any shape. In a preferred aspect, the reaction collar plate (FIG. 2E) is 30 inches square with a circular cut out in the center large enough for the reaction pipe (FIG. 1E) to pass through. The reaction collar plate (FIG. 2E) can be made from any material. In one aspect, the reaction collar plate (FIG. 2E) is made of metal, wood, plastics, composites or any other material and methods of manufacture. In a preferred aspect, the reaction collar plate (FIG. 2E) is made of steel. The reaction collar plate may be in one or more pieces to fit around the support dunnage or posts.

The thrust angle (FIG. 2C) is attached to the reaction plate or collar by welding, bolting or any structurally acceptable method. The thrust angle (FIG. 2C) serves to add support and strength to the bearing beams (FIG. 2F) and the reaction collar assemblies (FIG. 1F). The thrust angle (FIG. 2C) may or may not be required based on the size of the entire relocation and support device or machine attached to the invention. The thrust angle (FIG. 2C) can be of various shapes and sizes. In one aspect, the thrust angle (FIG. 2C) is 2 inches-12 inches in length, width and height depending on the size of the bearing beam. In a preferred aspect, the thrust angle (FIG. 2C) is 3 feet in length, 4 inches in height and 7 inches in width. The thrust angle (FIG. 2C) can be made from any material. In one aspect, the thrust angle (FIG. 2C) is made of metal, wood, plastics, composites or any other material and methods of manufacture. In a preferred aspect, the thrust angle (FIG. 2C) is made of steel.

The stiffener plates (FIG. 2D) are attached to the bearing beams (FIG. 2F) by welding, bolting or any structurally acceptable method. The stiffener plates (FIG. 2D) serves to add strength and support to the bearing beams (FIG. 2F). The stiffener plates (FIG. 2D) may or may not be required based on the size of the entire invention or machine attached to the invention. There is at least one of the stiffener plate (FIG. 2D) per reaction collar assembly (FIG. 1F). The stiffener plates (FIG. 2D) can be of various shapes and sizes. In one aspect, the stiffener plates (FIG. 2D) are 0.5 inch-10 inches in length, width and thickness depending on the size of the bearing beam. In a preferred aspect, the stiffener plates (FIG. 2D) is 6 inches in height, 3 inches wide and 1 inch thick. The stiffener plates (FIG. 2D) can be made from any material. In one aspect, the stiffener plates (FIG. 2D) is made of metal, wood, plastics, composites or any other material and methods of manufacture. In a preferred aspect, the stiffener plates (FIG. 2D) are made of steel.

The bearing beam assembly (FIG. 2F) serves to support the bearing pin (FIG. 3B) and the failsafe assemblies. The bearing beam assembly (FIG. 2F) is attached to the reaction plate or collar by welding, bolting or any structurally acceptable method. The bearing beam (FIG. 2F) assembly can be of various shapes and sizes. In one aspect, the bearing beam (FIG. 2F) assembly is 2 inches-24 inches in length, width and height. In a preferred aspect, the bearing beam (FIG. 2F) assembly is 3 feet in length, 6 inches in height and 6 inches in width. The bearing beam (FIG. 2F) assembly can be made from any material. In one aspect, the bearing beam (FIG. 2F) assembly is made of metal, wood, plastics, composites or any other material and methods of manufacture. In a preferred aspect, the bearing beam (FIG. 2F) assembly is made of steel.

The lifting beam (FIG. 2) serves to add strength and support to the bearing beams (FIG. 2F) and reaction collar assemblies and to attach the deadend of the relocation cable (FIG. 1I). The lifting beam is attached to the bearing beams (FIG. 2F) or reaction collar assemblies by removable pins or by welding, bolting or any structurally acceptable method. The lifting beam can be of various shapes and sizes. In one aspect, the lifting beam is 0.5 inches to 36 inches in length, diameter and thickness. In a preferred aspect, the lifting beam is 28 inches in length, 4.5 inches in diameter and 0.5 inches thick. The lifting beam can be made from any material. In one aspect, the lifting beam is made of metal, wood, plastics, composites or any other material and methods of manufacture. In a preferred aspect, the lifting beam is made of steel.

The lifting beam pin (FIG. 2) serves to attach the lifting beam to the bearing beam (FIG. 2F) in a easily installed and removable method. The lifting beam pin is attached to the lifting beam and the bearing beam (FIG. 2F) by bolts or removable lock pins or cotter pins. The lifting beam pin can be of various shapes and sizes. In one aspect, the lifting beam pin is 0.5 inch-10 inches in length and diameter. In a preferred aspect, the lifting beam pin is 8.5 inches in length and 1.5 inches in diameter. The lifting beam pin can be made from any material. In one aspect, the lifting beam pin is made of metal, wood, plastics, composites or any other material and methods of manufacture. In a preferred aspect, the lifting beam pin is made of steel.

The failsafe assembly or locks serve several unique functions such as an additional stabilizing attachment to the reaction collar assembly and as a positive mechanical gravity applied locking device such that the wedge block (FIG. 4D) is on an angle which as the reaction pipe ascends vertically, the failsafe roller is pushed up away from the reaction pipe (FIG. 1E) during the relocation operation. If the reaction pipe (FIG. 1E) started to descend for any reason the weight of the invention and the attached machine would cause the failsafe roller to moves down the angle of the wedge block (FIG. 4D) and thus causes the failesafe roller (FIG. 4C) to wedge against the reaction pipe (FIG. 1E) and stop the descent of the reaction pipe, the invention and the attached machine (FIG. 1A). The failsafe assembly or locks is attached to the bearing beam (FIG. 2F) or reaction collar assembly by welding, bolting or any structurally acceptable method.

The wedge block (FIG. 4D) serves to support the failsafe roller and to activate the locking feature of the invention. The wedge block (FIG. 4D) is attached to the bearing beam (FIG. 2F) by welding, bolting or any structurally acceptable method. The wedge block (FIG. 4D) can be of various shapes and sizes. In one aspect, the wedge block (FIG. 4D) has an angle of 1-10 degrees. The wedge block (FIG. 4D) can be made from any material. In a preferred aspect, the edge block has an angle of 7-10 degrees. In one aspect, the wedge block (FIG. 4D) is made of metal, wood, plastics, composites or any other material and methods of manufacture. In a preferred aspect, the wedge block (FIG. 4D) is made of steel.

The spacer block (FIG. 4E) serves to adjust the wedge block (FIG. 4D) and failsafe roller (FIG. 4C) into contact with the reaction pipe (FIG. 1E) and provides structural support to the failsafe assembly. The spacer block (FIG. 4E) is attached to the bearing beam (FIG. 2F) and the wedge block (FIG. 4D) by adjustment bolts, pins or similar device or method. The spacer block (FIG. 4E) can be of various shapes and sizes. In one aspect, spacer block (FIG. 4E) is 1 inch-10 in thickness, width and height. In a preferred aspect, the spacer block (FIG. 4E) is 3.5 inches wide, 5 inches in height and 2 inches thick. The spacer block (FIG. 4E) can be made from any material. In one aspect, the spacer block (FIG. 4E) is made of metal, wood, plastics, composites or any other material and methods of manufacture. In a preferred aspect, the spacer block (FIG. 4E) is made of steel.

The shim plates (FIG. 4B) serve to assist in the adjustment of the wedge block (FIG. 4D) and failsafe assemblies to properly contact the reaction pipe (FIG. 1E). The shim plates (FIG. 4B) can be attached to the bearing beams (FIG. 2F) or the wedge block (FIG. 4D) by welding, bolting or any structurally acceptable method. The shim plates (FIG. 4B) can be of various shapes and sizes. In one aspect, shim plates (FIG. 4B) is 1 inch-12 inches in height and width. In a preferred aspect, the shim plates (FIG. 4B) are 4.5 inches in height and 2.5 inches in width. The shim plates (FIG. 4B) can be made from any material. In one aspect, the shim plates (FIG. 4B) are made of metal, wood, plastics, composites or any other material and methods of manufacture. In a preferred aspect, the shim plates (FIG. 4B) are made of steel.

The failsafe stop roller (FIG. 4C) serves to create a positive and moveable or adjustable method of contact between the reaction pipe (FIG. 1E) and the wedge block (FIG. 4D) thereby allowing the invention to ascend while still providing a positive method to prevent the invention from descending or falling. The failsafe stop roller (FIG. 4C) is attached to the reaction pipe (FIG. 1E) and the wedge block (FIG. 4D) by gravity and physical contact. The failsafe stop roller (FIG. 4C) can be of various shapes and sizes. In one aspect, the failsafe stop roller (FIG. 4C) is 1 inch-12 inches in diameter and thickness. In a preferred aspect, the failsafe stop roller (FIG. 4C) is 2.5 inches in diameter inches and 1 inch thick. The failsafe stop roller (FIG. 4C) can be made from any material. In one aspect, the failsafe stop roller (FIG. 4C) is made of metal, wood, plastics, composites or any other material and methods of manufacture. In a preferred aspect, the failsafe stop roller (FIG. 4C) is made of steel.

The failsafe adjustment bolts (FIG. 4F) serve to assist in the adjustment of the spacer blocks (FIG. 4E), wedge blocks (FIG. 4D) and failsafe assemblies and rollers (FIG. 4C) to properly contact the reaction pipe (FIG. 1E). The failsafe adjustment bolts (FIG. 4F) are attached to the bearing beam (FIG. 2F) and the spacer blocks (FIG. 4E) through threads, adjustment holes or similarly adjustable method. The failsafe adjustment bolts (FIG. 4F) can be of various shapes and sizes. In one aspect, the failsafe adjustment bolts (FIG. 4F) are 0.25 inches-3 inches in diameter and length. In a preferred aspect, the failsafe adjustment bolts (FIG. 4F) are 1 inch in diameter and 4.5 inches in length. The failsafe adjustment bolts (FIG. 4F) can be made from any material. In one aspect, the failsafe adjustment bolts (FIG. 4F) are made of metal, wood, plastics, composites or any other material and methods of manufacture. In a preferred aspect, the failsafe adjustment bolts (FIG. 4F) are made of steel.

The failsafe seating bolt (FIG. 4A) serves to positively lock the wedge block (FIG. 4D) and failsafe assembly into the proper position after they are adjusted to properly contact the reaction pipe (FIG. 1E). The failsafe seating bolt (FIG. 4A) is attached to the bearing beam (FIG. 2F) and the wedge block (FIG. 4D) through threaded holes in both the bearing beam (FIG. 2F) and the wedge block (FIG. 4D). The failsafe seating bolt (FIG. 4A) can be of various shapes and sizes. In one aspect, the failsafe seating bolt (FIG. 4A) is 0.25 inches-6 inches in diameter and length. In a preferred aspect, the failsafe seating bolt (FIG. 4A) is 0.75 inches in diameter and 1.75 inches in length. The failsafe seating bolt (FIG. 4A) can be made from any material. In one aspect, the failsafe seating bolt (FIG. 4A) is made of metal, wood, plastics, composites or any other material and methods of manufacture. In a preferred aspect, the failsafe seating bolt (FIG. 4A) is made of steel.

A bearing pin (FIG. 3B) may pass through the reaction pipe (FIG. 1E) and rest on the center reaction collar assembly with bearing beams (FIG. 2F) installed this is called the bearing reaction collar. The bearing reaction collar assembly (FIG. 1F) is the reaction collar assembly (FIG. 1F) located on the highest level of the structure below the working deck or the highest floor yet to be constructed that the reaction pipe passes through. The bearing pin (FIG. 3B) serves to hold the reaction pipe (FIG. 1E) in place and it is attached to the bearing reaction collar assembly (FIG. 1F), which is secured to a floor or structure of sufficient strength and in a manner sufficient to transfer the load of the machine (FIG. 1A) to the structure. The bearing pin (FIG. 3B) may be of various sizes and made from various materials. In one aspect, the bearing pin (FIG. 3B) is 0.5 inch-6 inches in diameter and 6 inches-36 inches in length. In a preferred aspect the bearing pin (FIG. 3B) is 1 ⅜ inches in diameter and 24 inches in length. In one aspect, the bearing pin (FIG. 3B) is made of metal, wood, plastics, composites or any other material. In a preferred aspect, the bearing pin (FIG. 3B) is made of steel.

A relocation cable (FIG. 1H) which is connected from a reaction collar assembly (FIG. 1F) through one or more sheaves to a hoist. In one embodiment, the relocation cable (FIG. 1H) is attached to the upper most reaction collar assembly or what is commonly called the relocation collar assembly and is generally located at the highest floor that can structurally support the loads imposed by the invention and the attached machine. The relocation cable (FIG. 1H) runs down the length of the reaction pipe (FIG. 1E), around the lower relocation sheave(s) (FIG. 1G) or sheaves located at the bottom of the reaction pipe (FIG. 1E), up the length of the reaction pipe (FIG. 1E), inside the reaction pipe (FIG. 1E), around a first upper relocation sheave (FIG. 1C) and either to the optional relocation hoist or around a second upper relocation sheave (FIG. 1C) and connects to either the cable on the hoist of the machine in an industry acceptable method or directly to the hoist of the machine.

The relocations cable can be of various lengths and thicknesses. In one aspect, the relocation cable (FIG. 1H) is 20 feet-100 feet in length and 0.25 inches-6 inches thick. The relocation cable (FIG. 1H) can be made of various materials. In one aspect, the relocation cable (FIG. 1H) is made of metal, wood, plastics, rope, composites or any other material. In a preferred aspect, the relocation cable (FIG. 1H) is made of ⅝ inches by 50 feet in length.

The cable dead end (FIG. 1I) is located on to the uppermost reaction collar assembly (FIG. 1F) or what is commonly called the relocation collar assembly and is generally located at the highest floor that can structurally support the loads imposed by the invention and the attached machine. The cable dead end (FIG. 1I) functions to secure one end of the relocation cable (FIG. 1H) to the reaction collar assembly (FIG. 1F). The relocation cable (FIG. 1H) is attached to the cable dead end (FIG. 1I) through shackles, cables, bolts, clamps or other industry accepted methods. The cable dead end (FIG. 1I) could be of various sizes and shapes. In one aspect, the cable dead end (FIG. 1I) is a hollow or solid cylinder. In another aspect, the cable dead end (FIG. 1I) is a plate. In a preferred aspect, the cable dead end (FIG. 1I) is a hollow cylinder 24 inches long and 4.5 inches in diameter. The cable dead end (FIG. 1I) can be made of various materials. In one aspect, the cable dead end (FIG. 1I) is made of metal, wood, plastics, composites or any other material. In a preferred aspect, the cable dead end (FIG. 1I) is made of steel.

The relocation and support device of the invention provides support for the machine (FIG. 1A) by transferring the machine (FIG. 1A) loads to the structure. The relocation and support device of the invention vertically relocates the machine (FIG. 1A). To vertically relocate the machine (FIG. 1A) to a higher level the hoist winds the relocation cable (FIG. 1H) around itself, drawing the lower relocation sheave (FIG. 1G) and the reaction pipe (FIG. 1E) upwards thereby lifting the machine (FIG. 1A) to a higher vertical level. The reaction collar assembly (FIG. 1F) is portable and can be relocated each time the machine (FIG. 1A) is vertically relocated thereby reducing the number of reaction collar assembly (FIG. 1F) units needed.

In a unique embodiment of the invention, the failsafe system would allow the machine (FIG. 1A) to travel in an upward or vertical direction but would “wedge” against the reaction pipe (FIG. 1E) if a downward movement was attempted whether intentionally or unintentionally thereby preventing the machine (FIG. 1A) from lowering or falling unexpectedly due to mechanical failure or human error and provide a mechanical failsafe mechanism if any of the relocation system parts should fail.

What is claimed is:

1. A relocation and support device comprising:
a) a mounting flange;
b) at least 1 relocation sheave;
c) a reaction collar assembly;
d) a reaction pipe;
e) a bearing pin;
f) a relocation cable; and
g) a cable dead end.

2. The relocating and support device of claim 1, where in the device optionally comprises a relocation hoist or second upper relocation sheave.

3. The relocation and support device of claim 1, wherein the reaction assembly collar comprises: a reaction collar plate, a thrust angle, a stiffener plate, a bearing beam assembly, a lifting beam, a lifting beam pin, a failsafe assembly, a wedge block, a spacer block, a shim plate, a failsafe stop roller, a failsafe adjustment bolt and a failsafe seating bolt.

4. The relocation and support device of claim 1, wherein the device has a failsafe system comprised of a failsafe assembly, a wedge block, a spacer block, a shim plate, a failsafe stop roller, a failsafe adjustment bolt and a failsafe seating bolt.

5. The failsafe system of claim 4, wherein the wedge block is at an angle such that it prevents downward movement.

6. The relocation and support device of claim 1, wherein the reaction collar assembly can be relocated as the machine is vertically relocated.

7. A method of relocating a machine, the method comprising:
a) secure a lifting or relocation cable to a lifting beam pipe which is attached to a bearing beam;
b) a power source rotates a relocation hoist a sheave or series of hoists; and
c) a relocation cable winds over a relocation sheave onto or over the relocation hoist, sheave or sheaves;
wherein the machine is lifted to a higher vertical position.

8. The stabilizing device of claim 1, wherein the reaction collar assembly components are selected from the group consisting of: a reaction collar plate, a thrust angle, a stiffener plate, a bearing beam assembly, a lifting beam, a lifting beam pin, a failsafe assembly, a wedge block, a spacer block, a shim plate, a failsafe stop roller, a failsafe adjustment bolt and a failsafe seating bolt.

9. The relocation and support device of claim 1, wherein the device is attached to a machine that may or may not incorporate a hoist.

10. The use of a relocation and support device to relocate a machine.

11. The use of a relocation and support device to support a machine by transferring the machine load and the loads imposed by the machine performing its intended function to a structure.
